(19) United States
(12) Patent Application Publication
(10) Pub. No.: US 2024/0238986 A1
(43) Pub. Date: Jul. 18, 2024

(54) METHODS, SYSTEMS, APPARATUSES, AND DEVICES FOR FACILITATING INDEPENDENT MANIPULATION OF OBJECTS

(71) Applicant: Raahil Hiral Parikh, Andover, MA (US)

(72) Inventor: Raahil Hiral Parikh, Andover, MA (US)

(21) Appl. No.: 18/586,424

(22) Filed: Feb. 24, 2024

(51) Int. Cl. B25J 15/00

(52) U.S. Cl. CPC B25J 15/0033

(57) ABSTRACT

A gripping apparatus for facilitating independent manipulation of objects includes two gripping members comprising a first gripping member and a second gripping member, two gripping elements, and an actuator. The second gripping member is movable in a first direction in relation to the first gripping member. Each of the two gripping elements is comprised in a gripping portion of each of the two gripping members. The two gripping elements are characterized by at least one of a first gripping element portion and a second gripping element portion. The second gripping element portion is configured to be transitioned between an extended state and a collapsed state. The actuator transitions the second gripping member in relation to the first gripping member between positions for releasably holding objects between the gripping portion of the first gripping member and the gripping portion of the second gripping member.

### FIELD OF THE INVENTION

Generally, the present disclosure relates to the field of robots. More specifically, the present disclosure relates to methods, systems, apparatuses, and devices for facilitating independent manipulation of objects.

### BACKGROUND OF THE INVENTION

For industrial robots utilizing mechanical grippers, end-effectors typically restrict their functionality to gripping and releasing either individual objects or a designated group of objects simultaneously, but not manipulating multiple objects individually at the same time. However, the optimization of operational efficiency prompts a consideration for mechanical grippers capable of concurrently and independently manipulating multiple objects. Conventionally this is achieved through one of two methods: employing a double gripper, which utilizes two grippers to independently control multiple objects, or using multiple degrees of freedom (DOF) grippers characterized by numerous articulating joints. Both of these approaches entail high costs, complexity, and susceptibility to points of failure.

Existing techniques for facilitating independent manipulation of objects are deficient with regard to several aspects. For instance, current technologies require using multiple grippers for independent manipulation of objects. As a result, different technologies are needed that require a single gripper for independent manipulation of objects. Furthermore, current technologies use multiple degrees of freedom grippers for independent manipulation of objects. As a result, different technologies are needed that require a single degree of freedom gripper for independent manipulation of objects.

Therefore, there is a need for improved methods, systems, apparatuses, and devices for facilitating independent manipulation of objects that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a gripping apparatus for facilitating independent manipulation of objects, in accordance with some embodiments. Accordingly, the gripping apparatus may include two gripping members, two gripping elements, and an actuator. Further, the two gripping members may include a first gripping member and a second gripping member. Further, the second gripping member may be movable in at least one first direction in relation to the first gripping member. Further, each of the first gripping member and the second gripping member may include a gripping portion. Further, the two gripping elements may include a first gripping element and a second gripping element. Further, the first gripping element may be comprised in the gripping portion of the first gripping member and the second gripping element may be comprised in the gripping portion of the second gripping member. Further, the two gripping elements may be characterized by at least one of a first gripping element portion and at least one second gripping element portion. Further, the at least one second gripping element portion may be configured to be transitioned between at least one extended state and a collapsed state. Further, the actuator may be operably coupled with at least one of the first gripping member and the second gripping member. Further, the actuator may be configured for transitioning the second gripping member in relation to the first gripping member between a plurality of positions for releasably holding a plurality of objects between the gripping portion of the first gripping member and the gripping portion of the second gripping member. Further, the transitioning of the second gripping member between the plurality of positions may include transitioning the second gripping member from at least one first position of the plurality of positions to at least one second position of the plurality of positions for holding the plurality of objects. Further, the at least one second gripping element portion transitions to the collapsed state from the at least one extended state based on the transitioning of the second gripping member from the at least one first position to the at least one second position. Further, the transitioning of the second gripping member between the plurality of positions further may include transitioning the second gripping member in relation to the first gripping member from the at least one second position to at least one third position of the plurality of positions for releasing a first object of the plurality of objects while holding at least one second object of the plurality of objects. Further, the first object may be placed below the at least one second object. Further, the at least one second gripping element portion transitions to the at least one extended state from the collapsed state based on the transitioning of the second gripping member from the at least one second position to the at least one third position. Further, the transitioning of the second gripping member between the plurality of positions may include transitioning the second gripping member in relation to the first gripping member from the at least one third position to the at least one first position for releasing the at least one second object.

Further disclosed herein is a gripping apparatus for facilitating independent manipulation of objects, in accordance with some embodiments. Accordingly, the gripping apparatus may include two gripping members, two gripping elements, and an actuator. Further, the two gripping members may include a first gripping member and a second gripping member. Further, the second gripping member may be movable in at least one first direction in relation to the first gripping member. Further, each of the first gripping member and the second gripping member may include a gripping portion. Further, the two gripping elements may include a first gripping element and a second gripping element. Further, the first gripping element may be comprised in the gripping portion of the first gripping member and the second gripping element may be comprised in the gripping portion of the second gripping member. Further, the two gripping elements may be characterized by at least one of a first gripping element portion and at least one second gripping element portion. Further, the first gripping element may be characterized by the first gripping element portion and the at least one second gripping element portion. Further, the second gripping element may be characterized by the first gripping element portion. Further, the at least one second gripping element portion may be configured to be transitioned between at least one extended state and a collapsed state. Further, the actuator may be operably coupled with at least one of the first gripping member and the second gripping member. Further, the actuator may be configured for transitioning the second gripping member in relation to the first gripping member between a plurality of positions for releasably holding a plurality of objects between the gripping portion of the first gripping member and the gripping portion of the second gripping member. Further, the transitioning of the second gripping member between the plurality of positions may include transitioning the second gripping member from at least one first position of the plurality of positions to at least one second position of the plurality of positions for holding the plurality of objects. Further, the at least one second gripping element portion transitions to the collapsed state from the at least one extended state based on the transitioning of the second gripping member from the at least one first position to the at least one second position. Further, the transitioning of the second gripping member between the plurality of positions may include transitioning the second gripping member in relation to the first gripping member from the at least one second position to at least one third position of the plurality of positions for releasing a first object of the plurality of objects while holding at least one second object of the plurality of objects. Further, the first object may be placed below the at least one second object. Further, the at least one second gripping element portion transitions to the at least one extended state from the collapsed state based on the transitioning of the second gripping member from the at least one second position to the at least one third position. Further, the transitioning of the second gripping member between the plurality of positions may include transitioning the second gripping member in relation to the first gripping member from the at least one third position to the at least one first position for releasing the at least one second object. Further, each of the first gripping element portion and the at least one second gripping element portion may be characterized by a profile. Further, the profile of the first gripping element portion may be a first profile and the profile of the at least one second gripping element portion may be at least one second profile.

Further disclosed herein is a gripping apparatus for facilitating independent manipulation of objects, in accordance with some embodiments. Accordingly, the gripping apparatus may include two gripping members, two gripping elements, an actuator, and a frame. Further, the two gripping members may include a first gripping member and a second gripping member. Further, the second gripping member may be movable in at least one first direction in relation to the first gripping member. Further, each of the first gripping member and the second gripping member may include a gripping portion. Further, the two gripping elements may include a first gripping element and a second gripping element. Further, the first gripping element may be comprised in the gripping portion of the first gripping member and the second gripping element may be comprised in the gripping portion of the second gripping member. Further, the two gripping elements may be characterized by at least one of a first gripping element portion and at least one second gripping element portion. Further, the first gripping element may be characterized by the first gripping element portion and the at least one second gripping element portion. Further, the second gripping element may be characterized by the first gripping element portion. Further, the at least one second gripping element portion may be configured to be transitioned between at least one extended state and a collapsed state. Further, the at least one second gripping element portion may be characterized by at least one cavity of at least one shape comprised in the at least one second gripping element portion. Further, the at least one shape of the at least one cavity may be in at least one expanded state in the at least one extended state of the at least one second gripping element. Further, the at least one shape of the at least one cavity may be in at least one reduced state in the collapsed state. Further, the actuator may be operably coupled with at least one of the first gripping member and the second gripping member. Further, the actuator may be configured for transitioning the second gripping member in relation to the first gripping member between a plurality of positions for releasably holding a plurality of objects between the gripping portion of the first gripping member and the gripping portion of the second gripping member. Further, the transitioning of the second gripping member between the plurality of positions may include transitioning the second gripping member from at least one first position of the plurality of positions to at least one second position of the plurality of positions for holding the plurality of objects. Further, the at least one second gripping element portion transitions to the collapsed state from the at least one extended state based on the transitioning of the second gripping member from the at least one first position to the at least one second position. Further, the transitioning of the second gripping member between the plurality of positions may include transitioning the second gripping member in relation to the first gripping member from the at least one second position to at least one third position of the plurality of positions for releasing a first object of the plurality of objects while holding at least one second object of the plurality of objects. Further, the first object may be placed below the at least one second object. Further, the at least one second gripping element portion transitions to the at least one extended state from the collapsed state based on the transitioning of the second gripping member from the at least one second position to the at least one third position. Further, the transitioning of the second gripping member between the plurality of positions may include transitioning the second gripping member in relation to the first gripping member from the at least one third position to the at least one first position for releasing the at least one second object. Further, the frame may be configured for movably housing the two gripping members. Further, the actuator may be disposed on the frame.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a rear perspective view of a gripping apparatus 100 for facilitating independent manipulation of objects, in accordance with some embodiments.

FIG. 2 is a rear view of the gripping apparatus 100, in accordance with some embodiments.

FIG. 3 is a front view of the gripping apparatus 100, in accordance with some embodiments.

FIG. 4 is a front view of the gripping apparatus 100 for holding the plurality of objects 402-404, in accordance with some embodiments.

FIG. 5 is a front view of the gripping apparatus 100 for holding the at least one second object 404 after releasing the first object 402, in accordance with some embodiments.

FIG. 6 is a rear view of the two gripping members 102-104 of the gripping apparatus 100, in accordance with some embodiments.

FIG. 7 is a front view of the gripping apparatus 100, in accordance with some embodiments.

FIG. 8 is a front perspective view of the first gripping element 106 of the gripping apparatus 100, in accordance with some embodiments.

FIG. 9 is a front perspective view of the first gripping member 102 of the gripping apparatus 100, in accordance with some embodiments.

FIG. 10 is a front perspective view of the second gripping element 108 of the gripping apparatus 100, in accordance with some embodiments.

FIG. 11 is a front perspective view of the second gripping member 104 of the gripping apparatus 100, in accordance with some embodiments.

FIG. 12 is a rear perspective view of a gripping apparatus 1200 for facilitating independent manipulation of objects, in accordance with some embodiments.

FIG. 13 is a rear perspective view of a gripping apparatus 1300 for facilitating independent manipulation of objects, in accordance with some embodiments.

FIG. 14 is an illustration of an online platform 1400 consistent with various embodiments of the present disclosure.

FIG. 15 is a block diagram of a computing device 1500 for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating independent manipulation of objects, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

### Overview

The present disclosure describes methods, systems, apparatuses, and devices for facilitating independent manipulation of objects.

Further, the present disclosure describes a gripper, which is a low-cost single-DOF robotic gripper that uses a soft robotic mechanism on the arms of the gripper, made of compliant silicone that allows it to hold multiple objects at the same time and release them independently using a single actuator and three preset positions.

Further, the gripper may be a compliant multi-gripper and this compliant multi-gripper distinguishes itself by relying on a singular actuator and only two additional moving parts, the arms of the gripper itself. This design choice enhances simplicity in control and operation, significantly minimizing potential points of failure and overall costs. Comprising merely five precision-manufactured parts, molded silicone components, and an actuator, the compliant multi-gripper stands out as a cost-effective and reliable alternative. Moreover, its operational efficiency and adaptability surpass those of single grippers. The compliant multi-gripper demonstrates the ability to manipulate twice the quantity of objects with comparable speed and precision. Importantly, it can seamlessly function as a single gripper when necessary, further underscoring its versatility and practicality across diverse industrial applications.

Further, the gripper features two 3D-printed arms—one driven by an actuator and an idle arm designed to rotate in reverse of the powered arm. The powered arm incorporates a straightforward solid silicone lining, facilitating easy object grasping. Triangular dogs secure the silicone lining onto the gripper arms. The idle arm also has a silicone lining, with one segment being solid and less compressible, and a wider section with molded gaps, enabling partial compression and compliance. This design allows the simultaneous holding of two objects, one above the other. Upon slight actuator rotation toward the open position, the solid silicone grips on either side of the lower object disengage, and the lower object is released. Meanwhile, the compliant silicone mechanism gripping the upper object expands to its normal position, enlarging the gaps and functioning as a spring, ensuring a secure grip on the upper object, and effectively controlling the end effector. Through this mechanism, using only three preset positions, independent control of two objects is achievable with a single gripper.

Further, the disclosed gripper is extremely low in cost and complexity than the conventional gripper, allowing it to be quickly integrated into industrial environments, and has much fewer points of failure, with the only moving parts being the arms of the gripper itself and the actuator. As it can grip and independently release multiple objects, it can also increase the efficiency of industrial operations by an order of magnitude. It is also much more energy and time-efficient, and may also be used as a single or double (pick up and release both at the same time) gripper.

Further, the disclosed gripper includes molded compliant silicone grips with strategically placed gaps in them, to expand and comply predictably, allowing the gripper to hold two objects at the same time, but release them independently. Further, the disclosed gripper has an extremely low cost and level of complexity with three moving parts.

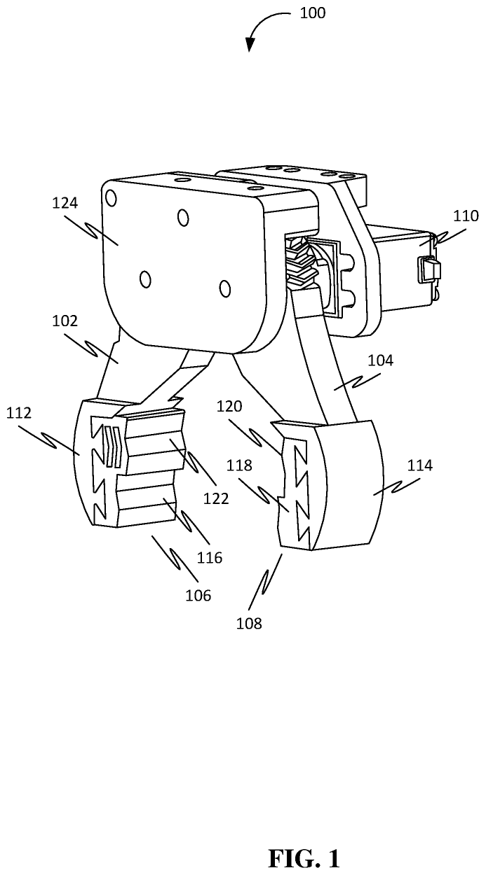

FIG. 1 is a rear perspective view of a gripping apparatus 100 for facilitating independent manipulation of objects, in accordance with some embodiments. Accordingly, the gripping apparatus 100 may include two gripping members 102-104, two gripping elements 106-108, and an actuator 110. Further, the gripping apparatus 100 may be a gripper. Further, the gripper may be a single-DOF robotic gripper.

Further, the two gripping members 102-104 may include a first gripping member 102 and a second gripping member 104. Further, the second gripping member 104 may be movable in at least one first direction in relation to the first gripping member 102. Further, each of the first gripping member 102 and the second gripping member 104 may include a gripping portion (112 and 114). Further, the two gripping members 102-104 may include an arm, a claw arm, etc. Further, the first gripping member 102 may include an idle arm. Further, the second gripping member 104 may include a powered arm. Further, the two gripping members 102-104 may be comprised of at least one non compliant material. Further, the at least one non compliant material may not be flexible. Further, the at least one non compliant material may include Polylactic acid (PLA) plastic, etc.

Further, the two gripping elements 106-108 may include a first gripping element 106 and a second gripping element 108. Further, the first gripping element 106 may be comprised in the gripping portion 112 of the first gripping member 102 and the second gripping element 108 may be comprised in the gripping portion 114 of the second gripping member 104. Further, the two gripping elements 106-108 may be characterized by at least one of a first gripping element portion (116 and 118-120) and at least one second gripping element portion 122. Further, the at least one second gripping element portion 122 may be configured to be transitioned between at least one extended state and a collapsed state. Further, the at least one second gripping element portion 122 may be substantially flexible, substantially compressible, etc.

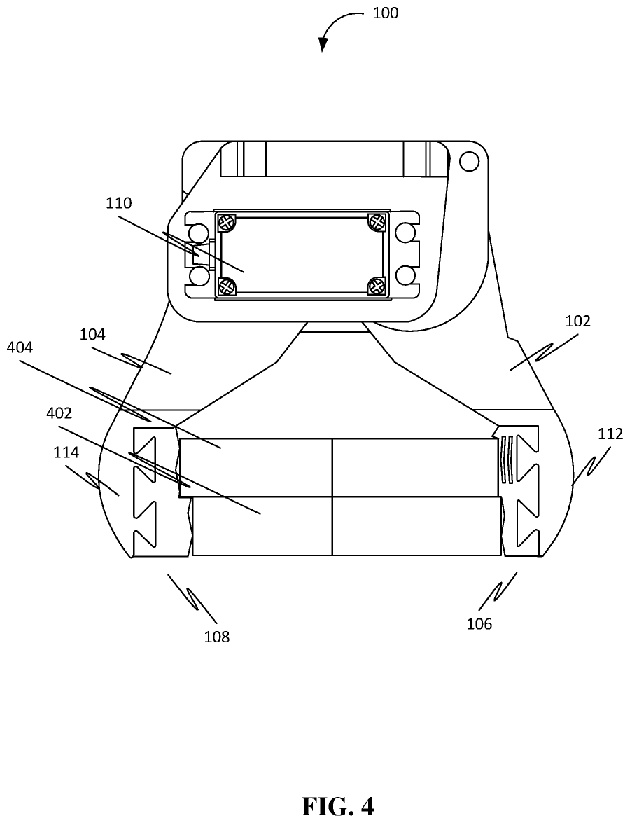

Further, the actuator 110 may be operably coupled with at least one of the first gripping member 102 and the second gripping member 104. Further, the actuator 110 may include an electric motor. Further, the electric motor may include a servo motor, a stepper motor, etc. Further, the actuator 110 may be configured for transitioning the second gripping member 104 in relation to the first gripping member 102 between a plurality of positions for releasably holding a plurality of objects 402-404, as shown in FIG. 4, between the gripping portion 112 of the first gripping member 102 and the gripping portion 114 of the second gripping member 104. Further, the plurality of objects 402-404 may be vertically stacked. Further, the transitioning of the second gripping member 104 between the plurality of positions may include transitioning the second gripping member 104 from at least one first position of the plurality of positions to at least one second position of the plurality of positions for holding the plurality of objects 402-404. Further, the at least one second gripping element portion 122 transitions to the collapsed state from the at least one extended state based on the transitioning of the second gripping member 104 from the at least one first position to the at least one second position. Further, the transitioning of the second gripping member 104 between the plurality of positions may include transitioning the second gripping member 104 in relation to the first gripping member 102 from the at least one second position to at least one third position of the plurality of positions for releasing a first object 402 of the plurality of objects 402-404 while holding at least one second object 404 of the plurality of objects 402-404. Further, the first object 402 may be placed below the at least one second object 404. Further, the at least one second gripping element portion 122 transitions to the at least one extended state from the collapsed state based on the transitioning of the second gripping member 104 from the at least one second position to the at least one third position. Further, the transitioning of the second gripping member 104 between the plurality of positions may include transitioning the second gripping member 104 in relation to the first gripping member 102 from the at least one third position to the at least one first position for releasing the at least one second object 404.

Further, in some embodiments, each of the first gripping element 106 and the second gripping element 108 may include a gripping surface. Further, the gripping surface may be characterized by at least one gripping feature. Further, the at least one gripping feature may include at least one protrusion and at least one recess adjacent to the at least one protrusion. Further, the at least one gripping feature of the gripping surface of the first gripping element 106 complements the at least one gripping feature of the gripping surface of the second gripping element 108.

Further, in an embodiment, the first gripping element 106 may be characterized by the first gripping element portion 116 and the at least one second gripping element portion 122. Further, the second gripping element 108 may be characterized by the first gripping element portion 118-120. Further, the first gripping element portion 116 may be disparate from the at least one second gripping element portion 122.

Further, in some embodiments, the gripping portion (112 and 114) of the first gripping member 102 and the second gripping member 104 apply at least one gripping force on the plurality of objects 402-404 based on the transitioning of the second gripping member 104 to the at least one second position in relation to the second gripping member 104 for the holding of the plurality of objects 402-404. Further, the gripping portion (112 and 114) of the first gripping member 102 and the second gripping member 104 removes the at least one gripping force from the first object 402 and retains the at least one gripping force on the at least one second object 404 based on the transitioning of the second gripping member 104 to the at least one third position for the releasing of the first object 402 of the plurality of objects 402-404 while holding the at least one second object 404. Further, the gripping portion (112 and 114) of the first gripping member 102 and the second gripping member 104 removes the at least one gripping force from the at least one second object 404 based on the transitioning of the second gripping member 104 to the at least one first position for the releasing of the at least one second object 404.

Further, in an embodiment, each of the first gripping element portion (116 and 118-120) and the at least one second gripping element portion 122 presses against at least one of the plurality of objects 402-404 based on an application of the at least one gripping force. Further, each of the first gripping element portion (116 and 118-120) and the at least one second gripping element portion 122 does not press against at least one of the plurality of objects 402-404 based on a removal of the at least one gripping force.

Further, in an embodiment, the at least one second gripping element portion 122 presses against at least one of the plurality of objects 402-404 based on the application of the at least one gripping force in each of the at least one extended state and the collapsed state.

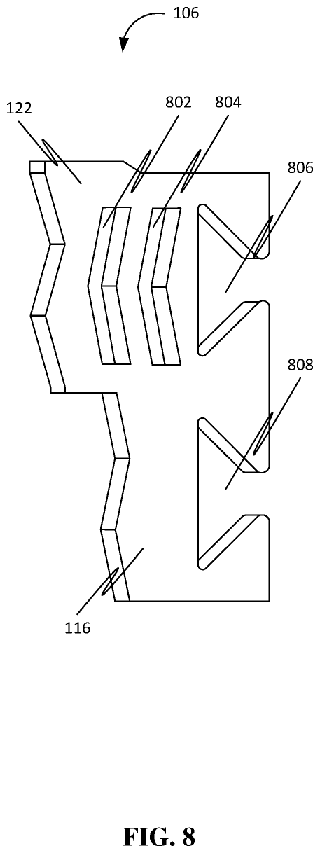

Further, in an embodiment, the at least one second gripping element portion 122 may be characterized by at least one cavity 802-804, as shown in FIG. 8, of at least one shape comprised in the at least one second gripping element portion 122. Further, the at least one shape of the at least one cavity 802-804 may be in at least one expanded state in the at least one extended state of the at least one second gripping element portion 122. Further, the at least one shape of the at least one cavity 802-804 may be in at least one reduced state in the collapsed state. Further, in an embodiment, the at least one second gripping element portion 122 may be configured to be transitioned predictably between the at least one extended state and the collapsed state based on the transitioning of the at least one cavity between the at least one expanded state and the at least one reduced state.

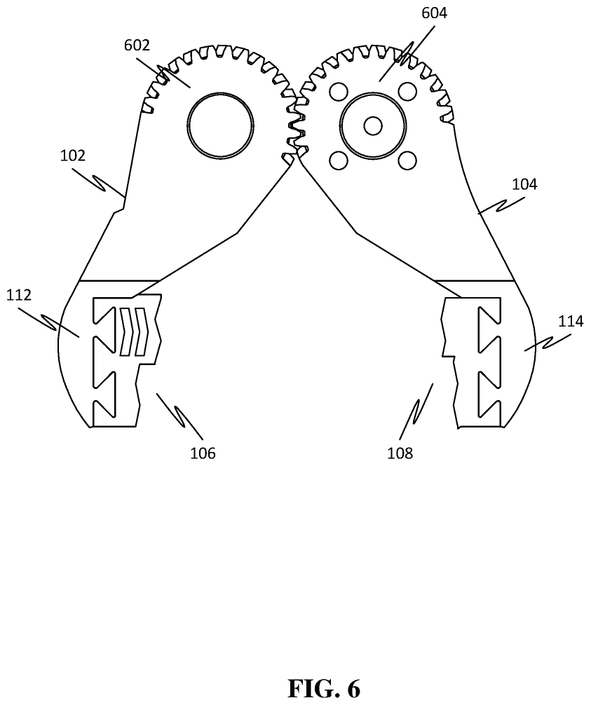

Further, in some embodiments, each of the first gripping member 102 and the second gripping member 104 may include an engaging portion (602 and 604), as shown in FIG. 6. Further, the engaging portion (602 and 604) of each of the first gripping member 102 and the second gripping member 104 are movably engaged. Further, the moving of the first gripping member 102 in the at least one first direction in relation to the second gripping member 104 moves the second gripping member 104 in at least one second direction in relation to the first gripping member 102 based on the movably engaging. Further, the at least one second direction may be opposite of the at least one first direction. Further, the engaging portion (602 and 604) may include a plurality of teeth. Further, the plurality of teeth of the engaging portion (602 and 604) of each of the first gripping member 102 and the second gripping member 104 are rotatably engaged.

Further, in an embodiment, the first gripping member 102 and the second gripping member 104 synchronously move based on the movably engaging.

Further, in some embodiments, the first gripping element 106 may be comprised of at least one compliant material. Further, the at least one compliant material may include a compliant silicone. Further, the first gripping element 106 may be a compliant molded silicone grip. Further, the at least one compliant material may be substantially and variably flexible, substantially and variably compressible, etc.

Further, in some embodiments, the second gripping element 108 may be comprised of at least one non compliant material. Further, the at least one non compliant material. Further, the at least one non compliant material may include a non compliant silicone. Further, the second gripping element 108 may be a non compliant molded silicone grip. Further, the at least one non compliant material may be substantially non flexible, substantially non compressible, etc.

Further, in some embodiments, the first gripping element portion (116 and 118-120) does not transition between the at least one extended state and the collapsed state. Further, the first gripping element portion (116 and 118-120) may not be substantially flexible, substantially compressible, etc.

Further, in some embodiments, each of the first gripping element portion (116 and 118-120) and the at least one second gripping element portion 122 may be characterized by a profile. Further, the profile of the first gripping element portion (116 and 118-120) may be a first profile and the profile of the at least one second gripping element portion 122 may be at least one second profile. Further, the profile may correspond to a thickness of the first gripping element portion (116 and 118-120) and the at least one second gripping element portion 122.

Further, in an embodiment, the profile of the at least one second gripping element portion 122 may be transitionable between the at least one second profile and the first profile based on the transitioning of the at least one second gripping element portion 122 between the at least one extended state and the collapsed state. Further, the at least one second profile corresponds to the at least one extended state and the first profile corresponds to the collapsed state. Further, the at least one second gripping element portion 122 may flush with the first gripping element portion (116 and 118-120) based on the transitioning of the at least one second gripping element portion 122 from the at least one extended state to the collapsed state.

In further embodiments, the gripping apparatus 100 may include a frame 124. Further, the frame 124 may be configured for movably housing the two gripping members 102-104. Further, the actuator 110 may be disposed on the frame 124. Further, the movably housing may include rotatably housing of the two gripping members 102-104.

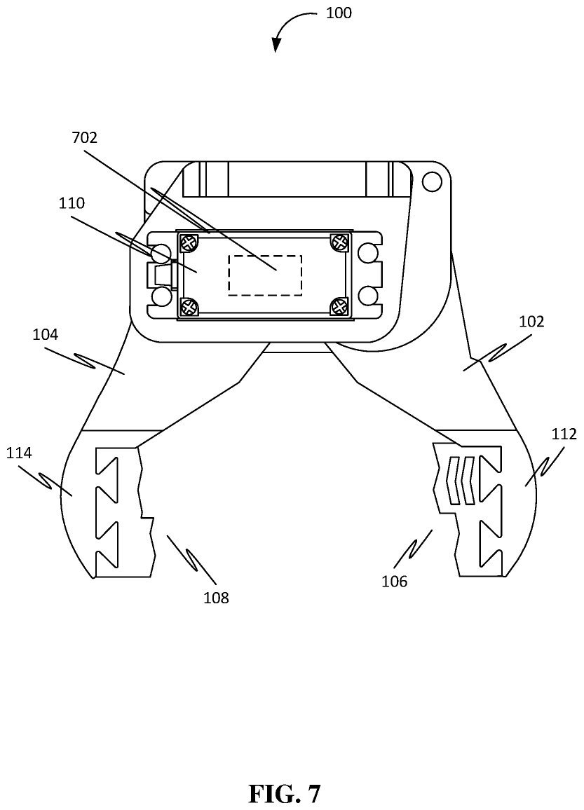

In further embodiments, the gripping apparatus 100 may include at least one communication interface 702, as shown in FIG. 7. Further, the at least one communication interface 702 may be communicatively coupled with the actuator 110. Further, the at least one communication interface 702 may be configured for receiving at least one input associated with at least one operation associated with the gripping apparatus 100. Further, the at least one operation corresponds to the independent manipulation of the plurality of objects 402-404. Further, the independent manipulation may include independently releasing and holding the plurality of objects 402-404. Further, the transitioning of the second gripping member 104 in relation to the first gripping member 102 between the plurality of positions may be based on the at least one input. Further, the at least one input may be received from at least one device. Further, the at least one device may include a computing device, a client device, etc.

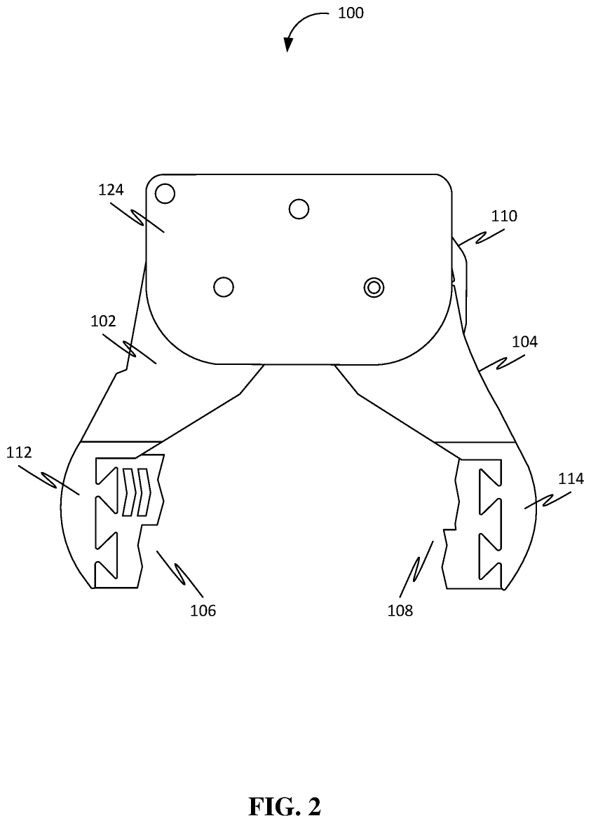

FIG. 2 is a rear view of the gripping apparatus 100, in accordance with some embodiments.

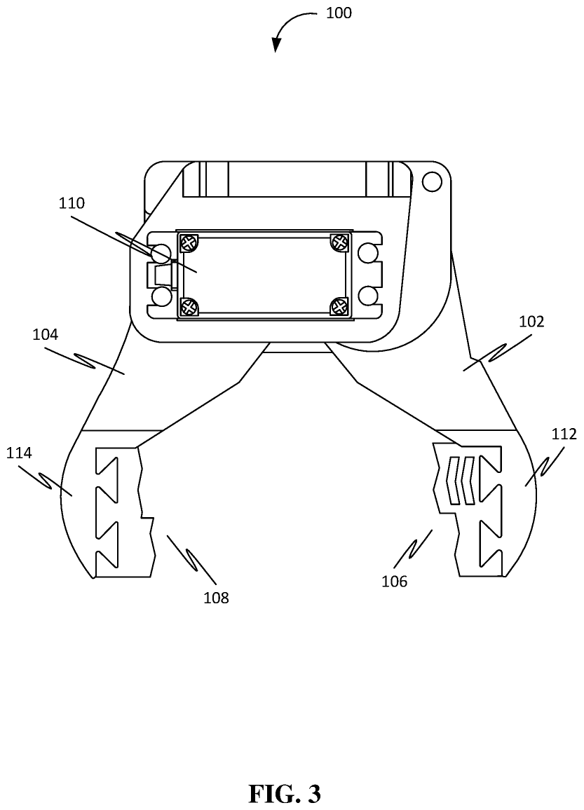

FIG. 3 is a front view of the gripping apparatus 100, in accordance with some embodiments.

FIG. 4 is a front view of the gripping apparatus 100 for holding the plurality of objects 402-404, in accordance with some embodiments.

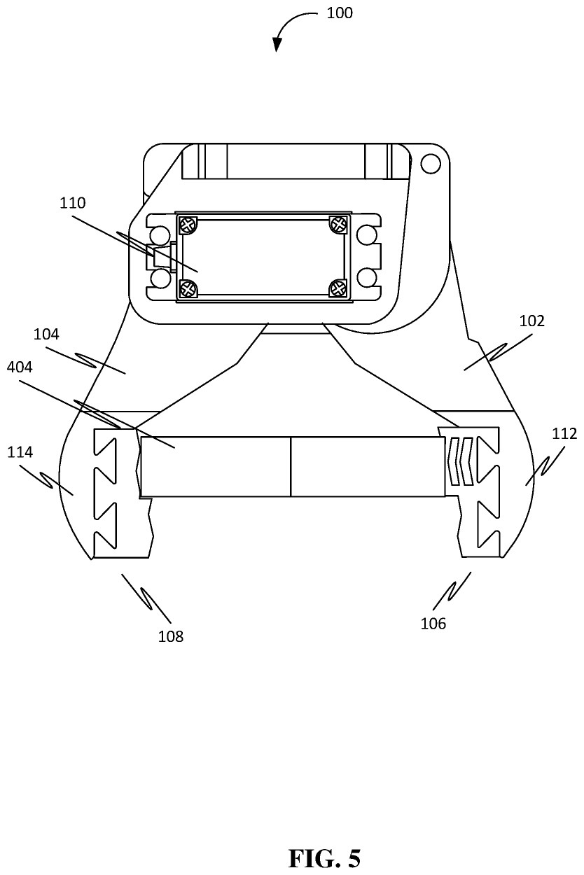

FIG. 5 is a front view of the gripping apparatus 100 for holding the at least one second object 404 after releasing the first object 402, in accordance with some embodiments.

FIG. 6 is a rear view of the two gripping members 102-104 of the gripping apparatus 100, in accordance with some embodiments.

FIG. 7 is a front view of the gripping apparatus 100, in accordance with some embodiments.

FIG. 8 is a front perspective view of the first gripping element 106 of the gripping apparatus 100, in accordance with some embodiments. Further, the first gripping element 106 may include at least one recess 806-808.

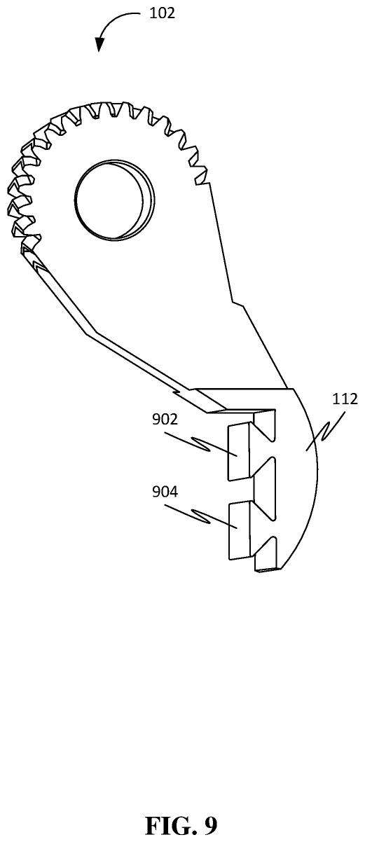

FIG. 9 is a front perspective view of the first gripping member 102 of the gripping apparatus 100, in accordance with some embodiments. Further, the first gripping member 102 may include at least one protrusion 902-904 in the gripping portion 112 of the first gripping member 102. Further, the at least one protrusion 902-904 may be insertable in the at least one recess 806-808 for securing the first gripping element 106 to the gripping portion 112 of the first gripping member 102. Further, the at least one protrusion 902-904 may include a triangular dog. Further, in an embodiment, the at least one protrusion 902-904 may be removably insertable in the at least one recess 806-808.

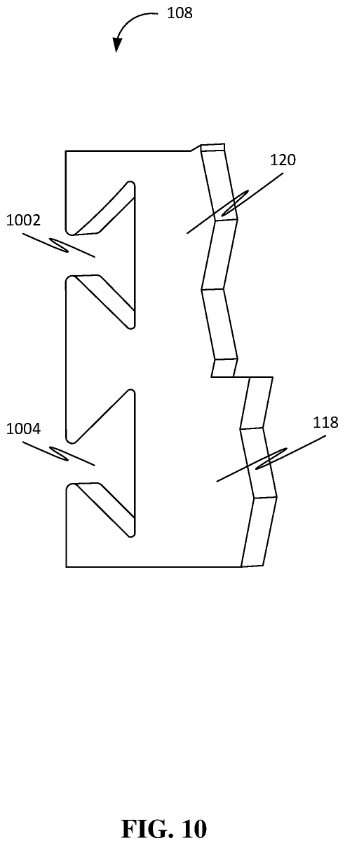

FIG. 10 is a front perspective view of the second gripping element 108 of the gripping apparatus 100, in accordance with some embodiments. Further, the second gripping element 108 may include at least one recess 1002-1004.

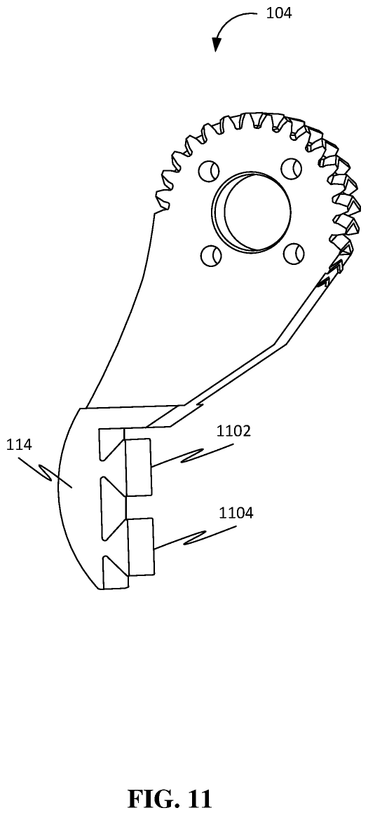

FIG. 11 is a front perspective view of the second gripping member 104 of the gripping apparatus 100, in accordance with some embodiments. Further, the second gripping member 104 may include at least one protrusion 1102-1104 in the gripping portion 114 of the second gripping member 104. Further, the at least one protrusion 1102-1104 may be insertable in the at least one recess 1002-1004 for securing the second gripping element 108 to the gripping portion 114 of the second gripping member 104.

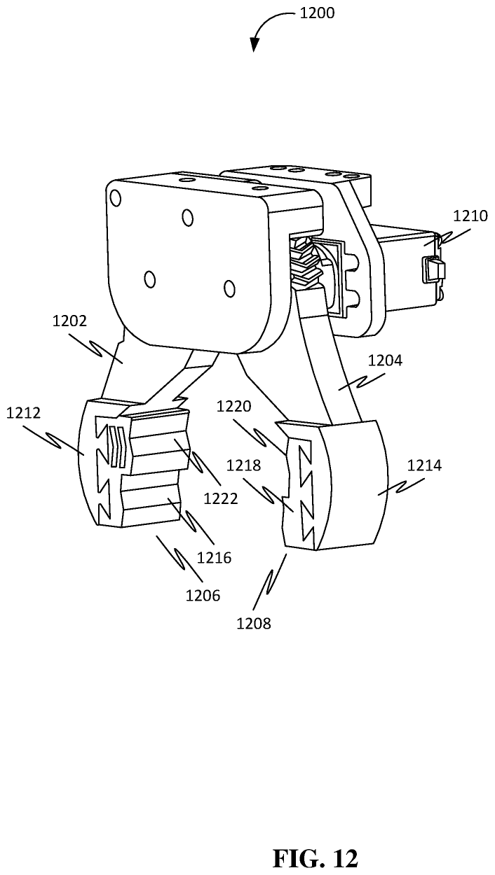

FIG. 12 is a rear perspective view of a gripping apparatus 1200 for facilitating independent manipulation of objects, in accordance with some embodiments. Accordingly, the gripping apparatus 1200 may include two gripping members 1202-1204, two gripping elements 1206-1208, and an actuator 1210.

Further, the two gripping members 1202-1204 may include a first gripping member 1202 and a second gripping member 1204. Further, the second gripping member 1204 may be movable in at least one first direction in relation to the first gripping member 1202. Further, each of the first gripping member 1202 and the second gripping member 1204 may include a gripping portion (1212 and 1214).

Further, the two gripping elements 1206-1208 may include a first gripping element 1206 and a second gripping element 1208. Further, the first gripping element 1206 may be comprised in the gripping portion 1212 of the first gripping member 1202 and the second gripping element 1208 may be comprised in the gripping portion 1214 of the second gripping member 1204. Further, the two gripping elements 1206-1208 may be characterized by at least one of a first gripping element portion (1216 and 1218-1220) and at least one second gripping element portion 1222. Further, the first gripping element 1206 may be characterized by the first gripping element portion 1216 and the at least one second gripping element portion 1222. Further, the second gripping element 1208 may be characterized by the first gripping element portion 1218-1220. Further, the at least one second gripping element portion 1222 may be configured to be transitioned between at least one extended state and a collapsed state. Further, each of the first gripping element portion (1216 and 1218-1220) and the at least one second gripping element portion 1222 may be characterized by a profile. Further, the profile of the first gripping element portion (1216 and 1218-1220) may be a first profile and the profile of the at least one second gripping element portion 1222 may be at least one second profile.

Further, the actuator 1210 may be operably coupled with at least one of the first gripping member 1202 and the second gripping member 1204. Further, the actuator 1210 may be configured for transitioning the second gripping member 1204 in relation to the first gripping member 1202 between a plurality of positions for releasably holding a plurality of objects between the gripping portion 1212 of the first gripping member 1202 and the gripping portion 1214 of the second gripping member 1204. Further, the transitioning of the second gripping member 1204 between the plurality of positions may include transitioning the second gripping member 1204 from at least one first position of the plurality of positions to at least one second position of the plurality of positions for holding the plurality of objects. Further, the at least one second gripping element portion 1222 transitions to the collapsed state from the at least one extended state based on the transitioning of the second gripping member 1204 from the at least one first position to the at least one second position. Further, the transitioning of the second gripping member 1204 between the plurality of positions further may include transitioning the second gripping member 1204 in relation to the first gripping member 1202 from the at least one second position to at least one third position of the plurality of positions for releasing a first object of the plurality of objects while holding at least one second object of the plurality of objects. Further, the first object may be placed below the at least one second object. Further, the at least one second gripping element portion 1222 transitions to the at least one extended state from the collapsed state based on the transitioning of the second gripping member 1204 from the at least one second position to the at least one third position. Further, the transitioning of the second gripping member 1204 between the plurality of positions may include transitioning the second gripping member 1204 in relation to the first gripping member 1202 from the at least one third position to the at least one first position for releasing the at least one second object.

Further, in some embodiments, the first gripping element 1206 may be comprised of at least one compliant material.

Further, in some embodiments, the second gripping element 1208 may be comprised of at least non compliant material.

Further, in some embodiments, the profile of the at least one second gripping element portion 1222 may be transitionable between the at least one second profile and the first profile based on the transitioning of the at least one second gripping element portion 1222 between the at least one extended state and the collapsed state. Further, the at least one second profile corresponds to the at least one extended state and the first profile corresponds to the collapsed state.

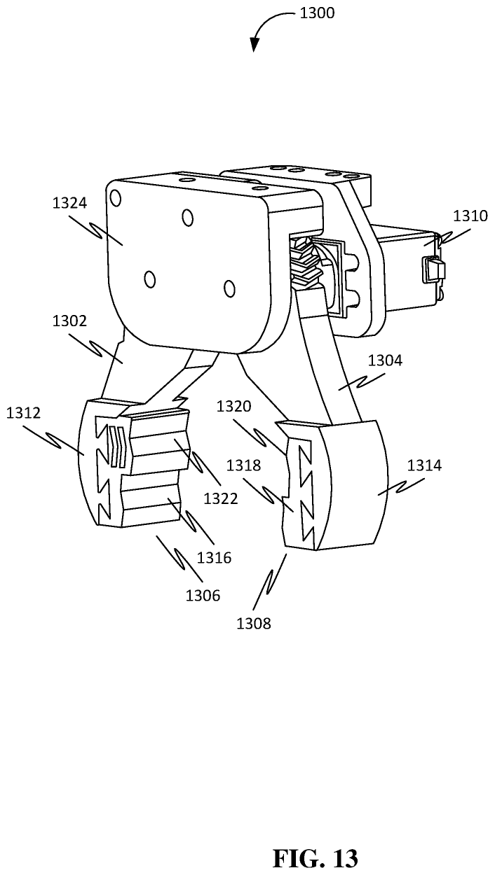

FIG. 13 is a rear perspective view of a gripping apparatus 1300 for facilitating independent manipulation of objects, in accordance with some embodiments. Accordingly, the gripping apparatus 1300 may include two gripping members 1302-1304, two gripping elements 1306-1308, an actuator 1310, and a frame 1324.

Further, the two gripping members 1302-1304 may include a first gripping member 1302 and a second gripping member 1304. Further, the second gripping member 1304 may be movable in at least one first direction in relation to the first gripping member 1302. Further, each of the first gripping member 1302 and the second gripping member 1304 may include a gripping portion (1312 and 1314).

Further, the two gripping elements 1306-1308 may include a first gripping element 1306 and a second gripping element 1308. Further, the first gripping element 1306 may be comprised in the gripping portion 1312 of the first gripping member 1302 and the second gripping element 1308 may be comprised in the gripping portion 1314 of the second gripping member 1304. Further, the two gripping elements 1306-1308 may be characterized by at least one of a first gripping element portion (1316 and 1318-1320) and at least one second gripping element portion 1322. Further, the first gripping element 1306 may be characterized by the first gripping element portion 1316 and the at least one second gripping element portion 1322. Further, the second gripping element 1308 may be characterized by the first gripping element portion 1318-1320. Further, the at least one second gripping element portion 1322 may be configured to be transitioned between at least one extended state and a collapsed state. Further, the at least one second gripping element portion 1322 may be characterized by at least one cavity of at least one shape comprised in the at least one second gripping element portion 1322. Further, the at least one shape of the at least one cavity may be in at least one expanded state in the at least one extended state of the at least one second gripping element portion. Further, the at least one shape of the at least one cavity may be in at least one reduced state in the collapsed state.

Further, the actuator 1310 may be operably coupled with at least one of the first gripping member 1302 and the second gripping member 1304. Further, the actuator 1310 may be configured for transitioning the second gripping member 1304 in relation to the first gripping member 1302 between a plurality of positions for releasably holding a plurality of objects between the gripping portion 1312 of the first gripping member 1302 and the gripping portion 1314 of the second gripping member 1304. Further, the transitioning of the second gripping member 1304 between the plurality of positions may include transitioning the second gripping member 1304 from at least one first position of the plurality of positions to at least one second position of the plurality of positions for holding the plurality of objects. Further, the at least one second gripping element portion 1322 transitions to the collapsed state from the at least one extended state based on the transitioning of the second gripping member 1304 from the at least one first position to the at least one second position. Further, the transitioning of the second gripping member 1304 between the plurality of positions further may include transitioning the second gripping member 1304 in relation to the first gripping member 1302 from the at least one second position to at least one third position of the plurality of positions for releasing a first object of the plurality of objects while holding at least one second object of the plurality of objects. Further, the first object may be placed below the at least one second object. Further, the at least one second gripping element portion 1322 transitions to the at least one extended state from the collapsed state based on the transitioning of the second gripping member 1304 from the at least one second position to the at least one third position. Further, the transitioning of the second gripping member 1304 between the plurality of positions may include transitioning the second gripping member 1304 in relation to the first gripping member 1302 from the at least one third position to the at least one first position for releasing the at least one second object.

Further, the frame 1324 may be configured for movably housing the two gripping members 1302-1304. Further, the actuator 1310 may be disposed on the frame 1324.

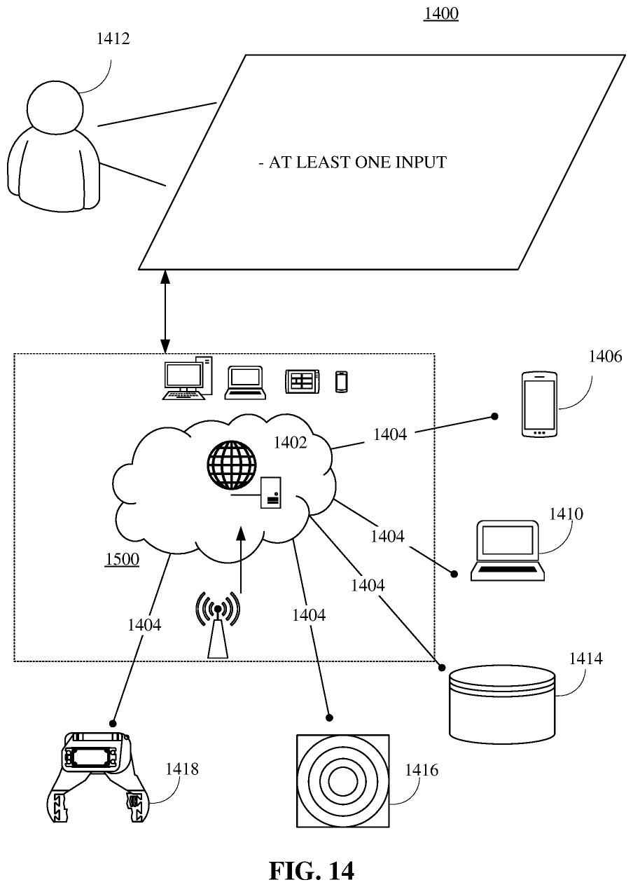

FIG. 14 is an illustration of an online platform 1400 consistent with various embodiments of the present disclosure. By way of non-limiting example, the online platform 1400 to facilitate independent manipulation of objects may be hosted on a centralized server 1402, such as, for example, a cloud computing service. The centralized server 1402 may communicate with other network entities, such as, for example, a mobile device 1406 (such as a smartphone, a laptop, a tablet computer, etc.), other electronic devices 1410 (such as desktop computers, server computers, etc.), databases 1414, sensors 1416, and a gripping apparatus 1418 (such as the gripping apparatus 100, the gripping apparatus 1200, and the gripping apparatus 1300) over a communication network 1404, such as, but not limited to, the Internet. Further, users of the online platform 1400 may include relevant parties such as, but not limited to, end-users, administrators, and so on. Accordingly, in some instances, electronic devices operated by the one or more relevant parties may be in communication with the platform.

A user 1412, such as the one or more relevant parties, may access online platform 1400 through a web based software application or browser. The web based software application may be embodied as, for example, but not be limited to, a website, a web application, a desktop application, and a mobile application compatible with a computing device 1500.

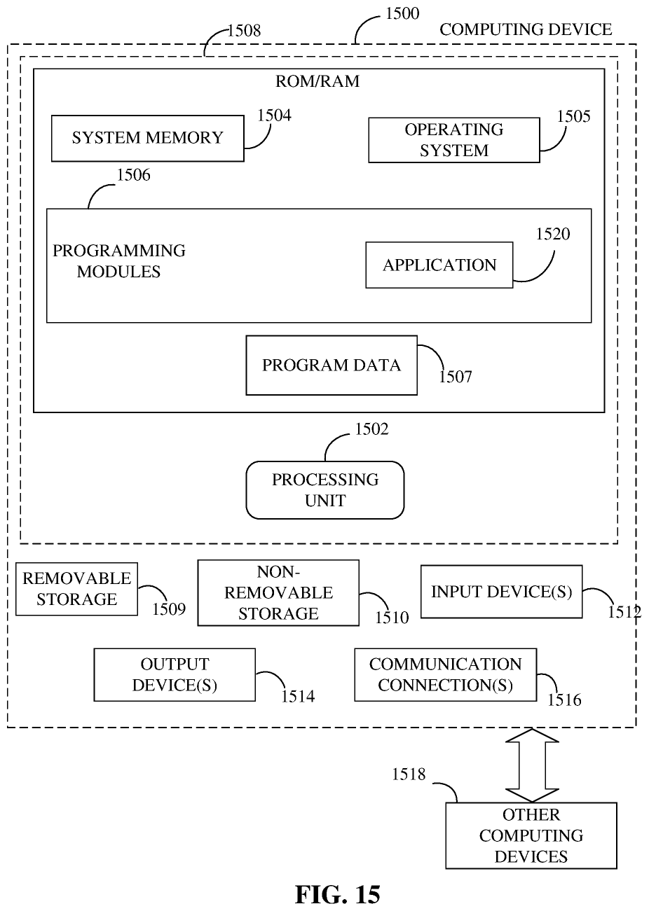

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A gripping apparatus for facilitating independent manipulation of objects, the gripping apparatus comprising:
two gripping members comprising a first gripping member and a second gripping member, wherein the second gripping member is movable in at least one first direction in relation to the first gripping member, wherein each of the first gripping member and the second gripping member comprises a gripping portion;
two gripping elements comprising a first gripping element and a second gripping element, wherein the first gripping element is comprised in the gripping portion of the first gripping member and the second gripping element is comprised in the gripping portion of the second gripping member, wherein the two gripping elements are characterized by at least one of a first gripping element portion and at least one second gripping element portion, wherein the at least one second gripping element portion is configured to be transitioned between at least one extended state and a collapsed state; and
an actuator operably coupled with at least one of the first gripping member and the second gripping member, wherein the actuator is configured for transitioning the second gripping member in relation to the first gripping member between a plurality of positions for releasably holding a plurality of objects between the gripping portion of the first gripping member and the gripping portion of the second gripping member, wherein the transitioning of the second gripping member between the plurality of positions comprises transitioning the second gripping member from at least one first position of the plurality of positions to at least one second position of the plurality of positions for holding the plurality of objects, wherein the at least one second gripping element portion transitions to the collapsed state from the at least one extended state based on the transitioning of the second gripping member from the at least one first position to the at least one second position, wherein the transitioning of the second gripping member between the plurality of positions further comprises transitioning the second gripping member in relation to the first gripping member from the at least one second position to at least one third position of the plurality of positions for releasing a first object of the plurality of objects while holding at least one second object of the plurality of objects, wherein the first object is placed below the at least one second object, wherein the at least one second gripping element portion transitions to the at least one extended state from the collapsed state based on the transitioning of the second gripping member from the at least one second position to the at least one third position, wherein the transitioning of the second gripping member between the plurality of positions further comprises transitioning the second gripping member in relation to the first gripping member from the at least one third position to the at least one first position for releasing the at least one second object.

2. The gripping apparatus of claim 1, wherein the first gripping element is characterized by the first gripping element portion and the at least one second gripping element portion, wherein the second gripping element is characterized by the first gripping element portion.

3. The gripping apparatus of claim 1, wherein the gripping portion of the first gripping member and the second gripping member apply at least one gripping force on the plurality of objects based on the transitioning of the second gripping member to the at least one second position in relation to the second gripping member for the holding of the plurality of objects, wherein the gripping portion of the first gripping member and the second gripping member removes the at least one gripping force from the first object and retains the at least one gripping force on the at least one second object based on the transitioning of the second gripping member to the at least one third position for the releasing of the first object of the plurality of objects while holding the at least one second object, wherein the gripping portion of the first gripping member and the second gripping member removes the at least one gripping force from the at least one second object based on the transitioning of the second gripping member to the at least one first position for the releasing of the at least one second object.

4. The gripping apparatus of claim 3, wherein each of the first gripping element portion and the at least one second gripping element portion presses against at least one of the plurality of objects based on an application of the at least one gripping force, wherein each of the first gripping element portion and the at least one second gripping element portion does not press against at least one of the plurality of objects based on a removal of the at least one gripping force.

5. The gripping apparatus of claim 4, wherein the at least one second gripping element portion presses against at least one of the plurality of objects based on the application of the at least one gripping force in each of the at least one extended state and the collapsed state.

6. The gripping apparatus of claim 1, wherein the at least one second gripping element portion is characterized by at least one cavity of at least one shape comprised in the at least one second gripping element portion, wherein the at least one shape of the at least one cavity is in at least one expanded state in the at least one extended state of the at least one second gripping element portion, wherein the at least one shape of the at least one cavity is in at least one reduced state in the collapsed state.

7. The gripping apparatus of claim 1, wherein each of the first gripping member and the second gripping member comprises an engaging portion, wherein the engaging portion of each of the first gripping member and the second gripping member are movably engaged, wherein the moving of the first gripping member in the at least one first direction in relation to the second gripping member moves the second gripping member in at least one second direction in relation to the first gripping member based on the movably engaging, wherein the at least one second direction is opposite of the at least one first direction.

8. The gripping apparatus of claim 7, wherein the first gripping member and the second gripping member synchronously move based on the movably engaging.

9. The gripping apparatus of claim 1, wherein the first gripping element is comprised of at least one compliant material.

10. The gripping apparatus of claim 1, wherein the second gripping element is comprised of at least one non compliant material.

11. The gripping apparatus of claim 1, wherein the first gripping element portion does not transition between the at least one extended state and the collapsed state.

12. The gripping apparatus of claim 1, wherein each of the first gripping element portion and the at least one second gripping element portion is characterized by a profile, wherein the profile of the first gripping element portion is a first profile and the profile of the at least one second gripping element portion is at least one second profile.

13. The gripping apparatus of claim 12, wherein the profile of the at least one second gripping element portion is transitionable between the at least one second profile and the first profile based on the transitioning of the at least one second gripping element portion between the at least one extended state and the collapsed state, wherein the at least one second profile corresponds to the at least one extended state and the first profile corresponds to the collapsed state.

14. The gripping apparatus of claim 1 further comprising a frame configured for movably housing the two gripping members, wherein the actuator is disposed on the frame.

15. The gripping apparatus of claim 1 further comprising at least one communication interface communicatively coupled with the actuator, wherein the at least one communication interface is configured for receiving at least one input associated with at least one operation associated with the gripping apparatus, wherein the transitioning of the second gripping member in relation to the first gripping member between the plurality of positions is based on the at least one input.

16. A gripping apparatus for facilitating independent manipulation of objects, the gripping apparatus comprising:
two gripping members comprising a first gripping member and a second gripping member, wherein the second gripping member is movable in at least one first direction in relation to the first gripping member, wherein each of the first gripping member and the second gripping member comprises a gripping portion;
two gripping elements comprising a first gripping element and a second gripping element, wherein the first gripping element is comprised in the gripping portion of the first gripping member and the second gripping element is comprised in the gripping portion of the second gripping member, wherein the two gripping elements are characterized by at least one of a first gripping element portion and at least one second gripping element portion, wherein the first gripping element is characterized by the first gripping element portion and the at least one second gripping element portion, wherein the second gripping element is characterized by the first gripping element portion, wherein the at least one second gripping element portion is configured to be transitioned between at least one extended state and a collapsed state, wherein each of the first gripping element portion and the at least one second gripping element portion is characterized by a profile, wherein the profile of the first gripping element portion is a first profile and the profile of the at least one second gripping element portion is at least one second profile; and
an actuator operably coupled with at least one of the first gripping member and the second gripping member, wherein the actuator is configured for transitioning the second gripping member in relation to the first gripping member between a plurality of positions for releasably holding a plurality of objects between the gripping portion of the first gripping member and the gripping portion of the second gripping member, wherein the transitioning of the second gripping member between the plurality of positions comprises transitioning the second gripping member from at least one first position of the plurality of positions to at least one second position of the plurality of positions for holding the plurality of objects, wherein the at least one second gripping element portion transitions to the collapsed state from the at least one extended state based on the transitioning of the second gripping member from the at least one first position to the at least one second position, wherein the transitioning of the second gripping member between the plurality of positions further comprises transitioning the second gripping member in relation to the first gripping member from the at least one second position to at least one third position of the plurality of positions for releasing a first object of the plurality of objects while holding at least one second object of the plurality of objects, wherein the first object is placed below the at least one second object, wherein the at least one second gripping element portion transitions to the at least one extended state from the collapsed state based on the transitioning of the second gripping member from the at least one second position to the at least one third position, wherein the transitioning of the second gripping member between the plurality of positions further comprises transitioning the second gripping member in relation to the first gripping member from the at least one third position to the at least one first position for releasing the at least one second object.

17. The gripping apparatus of claim 16, wherein the first gripping element is comprised of at least one compliant material.

18. The gripping apparatus of claim 16, wherein the second gripping element is comprised of at least one non compliant material.

19. The gripping apparatus of claim 16, wherein the profile of the at least one second gripping element portion is transitionable between the at least one second profile and the first profile based on the transitioning of the at least one second gripping element portion between the at least one extended state and the collapsed state, wherein the at least one second profile corresponds to the at least one extended state and the first profile corresponds to the collapsed state.

20. A gripping apparatus for facilitating independent manipulation of objects, the gripping apparatus comprising:
two gripping members comprising a first gripping member and a second gripping member, wherein the second gripping member is movable in at least one first direction in relation to the first gripping member, wherein each of the first gripping member and the second gripping member comprises a gripping portion;
two gripping elements comprising a first gripping element and a second gripping element, wherein the first gripping element is comprised in the gripping portion of the first gripping member and the second gripping element is comprised in the gripping portion of the second gripping member, wherein the two gripping elements are characterized by at least one of a first gripping element portion and at least one second gripping element portion, wherein the first gripping element is characterized by the first gripping element portion and the at least one second gripping element portion, wherein the second gripping element is characterized by the first gripping element portion, wherein the at least one second gripping element portion is configured to be transitioned between at least one extended state and a collapsed state, wherein the at least one second gripping element portion is characterized by at least one cavity of at least one shape comprised in the at least one second gripping element portion, wherein the at least one shape of the at least one cavity is in at least one expanded state in the at least one extended state of the at least one second gripping element portion, wherein the at least one shape of the at least one cavity is in at least one reduced state in the collapsed state;
an actuator operably coupled with at least one of the first gripping member and the second gripping member, wherein the actuator is configured for transitioning the second gripping member in relation to the first gripping member between a plurality of positions for releasably holding a plurality of objects between the gripping portion of the first gripping member and the gripping portion of the second gripping member, wherein the transitioning of the second gripping member between the plurality of positions comprises transitioning the second gripping member from at least one first position of the plurality of positions to at least one second position of the plurality of positions for holding the plurality of objects, wherein the at least one second gripping element portion transitions to the collapsed state from the at least one extended state based on the transitioning of the second gripping member from the at least one first position to the at least one second position, wherein the transitioning of the second gripping member between the plurality of positions further comprises transitioning the second gripping member in relation to the first gripping member from the at least one second position to at least one third position of the plurality of positions for releasing a first object of the plurality of objects while holding at least one second object of the plurality of objects, wherein the first object is placed below the at least one second object, wherein the at least one second gripping element portion transitions to the at least one extended state from the collapsed state based on the transitioning of the second gripping member from the at least one second position to the at least one third position, wherein the transitioning of the second gripping member between the plurality of positions further comprises transitioning the second gripping member in relation to the first gripping member from the at least one third position to the at least one first position for releasing the at least one second object; and
a frame configured for movably housing the two gripping members, wherein the actuator is disposed on the frame.
